(19) United States
(12) Patent Application Publication
(10) Pub. No.: US 2025/0211537 A1
(43) Pub. Date: Jun. 26, 2025

(54) NETWORK NODES, AND METHODS FOR TRAFFIC STEERING POLICIES

(71) Applicant: Telefonaktiebolaget LM Ericsson (publ), Stockholm (SE)

(72) Inventors: Stefan Rommer, Vastra Frolunda (SE); Magnus Hallenstal, Taby (SE); Maria Luisa Mas Rosique, Tres Cantos Madrid (ES); Miguel Angel Munoz De La Torre Alonso, Madrid (ES); Antonio Canete Martinez, Madrid (ES); Robert Skog, Hasselby (SE); Julian Espinosa Santos, Madrid (ES)

(21) Appl. No.: 18/851,889

(22) PCT Filed: Mar. 27, 2023
(86) PCT No.: PCT/SE2023/050271

§ 371 Date: Sep. 27, 2024

(30) Foreign Application Priority Data
Mar. 29, 2022 (EP) 22382300.6

(51) Int. Cl. H04L 47/22; H04W 28/02

(52) U.S. Cl. CPC H04L 47/22; H04W 28/02

(57) ABSTRACT

A method, performed by a first network node implementing an Application Function, AF, in a wireless communications network for influencing traffic routing associated with a wireless communications device in the wireless communications network. The method comprises: 5 transmitting (601), to a second network node implementing a network exposure function of the wireless communications network or to a third network node implementing a policy and charging function of the wireless communications network, a request to influence the traffic routing associated with the wireless communications device. The request includes an indication of a traffic steering policy for a specific 10 traffic on a specific user session associated with the wireless communications device 121.

### TECHNICAL FIELD

The embodiments herein relate to network nodes and methods for traffic steering policies in a wireless communications network. A corresponding computer program and a computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas. Each service area or cell area may provide radio coverage via a beam or a beam group. Each service area or cell area is typically served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP). A Fifth Generation (5G) network also referred to as 5G New Radio (NR) has also been specified and work is now directed to further specifications of the 5G network. This work will continue in the coming 3GPP releases.

As a reference, the EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn is connected to a network node 106. The access nodes 103-104 are part of the radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGW). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 corresponds typically to an 5G NodeB (gNB) and the network node 106 corresponds typically to either an Access and Mobility Management Function (AMF) and/or a User Plane Function (UPF). The gNB is part of the radio access network 10, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs may also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.
FIG. 2 depicts a 5G reference architecture of policy and charging control framework as defined by 3GPP.
The following architectural aspects will be described in further detail below:
Application Function (AF)
Policy Control Function (PCF)
Session Management Function (SMF)
User Plane Function (UPF)

### AF

AF represents external trusted or non-trusted functions integrated in the operator network to interact with 5GC. The AF is part of the 5GC architecture and uses the mechanisms and interfaces specified for 5GC and OAM.

### PCF (Policy Control Function)

The Policy Control function (PCF) supports different functionality, e.g. unified policy framework to govern network behavior, provides policy rules to Control Plane function(s) to enforce them, and accesses subscription information relevant for policy decisions in a Unified Data Repository (UDR).

### SMF (Session Management Function)

The Session Management function (SMF) supports different functionalities, e.g. SMF receives Policy Charging and Control (PCC) rules from the PCF and configures the UPF accordingly.

SMF is the network function that has the information of which UPFs conform the user Protocol Data Unit (PDU) Session, and with which role (PDU Session Anchor, Branching Point, ULCL), and to which Data Network (DN) Access (or Data Network Access Identifier (DNAI)) they are steering the traffic to among other. The DNAI is an identifier of the Access to the DN when access has been distributed, e.g. for edge computing.

### UPF (User Plane Function)

The User Plane function (UPF) supports handling of user plane traffic based on the rules received from the SMF, e.g. packet inspection and different enforcement actions such as QoS handling.

### SUMMARY

Existing API enables an AF to influence traffic routing indirectly using a routing profile IDs within ‘Routing to Location’ element that may refer to a pre-agreed policy between the AF and the 5GC. The PCF(s) transform(s) the AF requests into PCC Rules that apply to PDU Sessions. This is further described e.g. in 3GPP TS 23.501 v17.4.0 “System Architecture for the 5G System; Stage 2” (clause 5.6.7) and 3GPP TS 29.514 v17.4.0 “5G System; Policy Authorization Service; Stage 3” in the Npcf_PolicyAuthorization Service (clause 4.2.2.8/4.2.3.8) and 3GPP TS 29.522 v17.5.0 “5G System; Network Exposure Function Northbound APIs” (clause 4.4.7). AF requests are sent to the PCF via N5 or via a Network Exposure Function (NEF) if non-trusted AF. If the AF request does not refer to a specific ongoing IP session, and instead e.g. refers to a group of UEs, the information provided by the AF is stored in UDR.

RouteToLocation element that finally shall be processed by PCF is described corresponding API and copied here:

```
  https://www.3gpp.org/ftp/Specs/archive/29 series/29.514/OpenAPI/2018-
12/TS29514 Npcf PolicyAuthorization.yaml
  https://www.3gpp.org/ftp/Specs/archive/OpenAPI/Rel-
15/TS29571 CommonData.yaml
    RouteToLocation:
      type: object
      properties:
        dnai:
          $ref: ‘#/components/schemas/Dnai’
        routeInfo:
          $ref: ‘#/components/schemas/RouteInformation’
        routeProfId:
          type: string
          nullable: true
  required:
        - dnai
      anyOf:
        - required: [ routeInfo ]
        - required: [ routeProfId ]
      nullable: true
    RouteInformation:
      type: object
      properties:
        ipv4Addr:
          $ref: ‘#/components/schemas/Ipv4Addr’
        ipv6Addr:
          $ref: ‘#/components/schemas/Ipv6Addr’
        portNumber:
          $ref: ‘#/components/schemas/Uinteger’
      required:
        - portNumber
      nullable: true
```

When the Traffic Influence API is used today, the PCF maps the routing information (e.g. Routing Profile IDs) received from AF to a RouteToLocation parameters provided in the PCC Rule. This is further described in 3GPP TS 23.503 “Policy and Charging Control Framework for the 5G System” (AF incluenced Traffic Steering Enforcement control).

| AF influenced | |
|---|---|
| Traffic Steering | This part describes |
| Enforcement Control | information required for AF |
| (NOTE 18) | influenced Traffic Steering. |
| Data Network | Identifier(s) of the target |
| Access Identifier | Data Network Access (DNAI). |
| | It is defined in clause 5.6.7 of |
| | 3GPP TS 23.501. |
| Per DNAI: Traffic | Reference to a pre- |
| steering policy | configured traffic steering |
| identifier | policy at the SMF (NOTE 19). |
| Per DNAI: N6 | Describes the information |
| traffic routing | necessary for traffic steering to |
| information | the DNAI. It is described in |
| | clause 5.6.7 of 3GPP |
| | TS 23.501 (NOTE 19). |

However, a problem is that the mapping between a profile information and the traffic steering policy only refer to a single Traffic Steering Policy without considering the specific traffic direction (UL or DL) so it cannot be used for asymmetric Service Function Chaining (SFC) where uplink and downlink paths differs.

An object of embodiments herein may be to obviate some of the problems related to influencing traffic routing.

Embodiments herein introduce explicit Traffic Steering policies for uplink and/or downlink when there is a need for the AF to influence 5GC routing. Thus, embodiments herein may provide a solution for enhancing an AF's influence on traffic routing with explicit uplink and/or downlink traffic steering identifiers. For example:
The AF may explicitly include uplink and downlink elements in the interface to influence the PCF directly or indirectly, e.g. through Network Exposure Function (NEF)). The elements may include explicit uplink and downlink traffic steering identifiers (IDs), such as AF-TSP-UL and/or AF-TSP-DL. Thus, the AF request may include both UL and DL TSP (AF-TSP-UL and/or AF-TSP-DL) or just one if any of the direction does not require a traffic steering.
PCF may use identifiers coming from AF directly to create the PCC rule related to a target flow. A flow is traffic between two peers identified by IP addresses and ports used by those peers and a transport protocol they use.
PCF may use AF-TSP IDs directly or maps to local defined TSP ID provided to the SMF in the PCC Rule so as to avoid the AF to know how TSP ID are set in the 5GC and therefore isolate it from system configuration changes.

According to an aspect of embodiments herein, the object is achieved by a method, performed by a first network node implementing an AF in a wireless communications network for influencing traffic routing associated with a wireless communications device in the wireless communications network, the method comprises:

transmitting, to a second network node implementing a network exposure function of the wireless communications network or to a third network node implementing a policy and charging function of the wireless communications network, a request to influence the traffic routing associated with the wireless communications device, wherein the request includes an indication of a traffic steering policy for a specific traffic on a specific user session associated with the wireless communications device.

The indication of the traffic steering policy request may include an indication of a first traffic steering policy for uplink traffic and/or a second traffic steering policy for downlink traffic.

The specific user session associated with the wireless communications device may be a user PDU session.

According to a second aspect of embodiments herein, the object is achieved by a first network node implementing an AF in a wireless communications network. The first network node is configured for influencing traffic routing associated with a wireless communications device in the wireless communications network. The first network node is further configured for performing the method according to the first aspect above.

According to a third aspect of embodiments herein, the object is achieved by a method, performed by a second network node implementing a NEF in a wireless communications network, for influencing traffic routing associated with a wireless communications device in the wireless communications network, the method comprises:
receiving, from a first network node implementing an Application Function, AF, in the wireless communications network, a request to influence the traffic routing associated with the wireless communications device, wherein the request includes an indication of a traffic steering policy for a specific traffic on a specific user session associated with the wireless communications device, and
transmitting, to a third network node implementing a policy and charging function of the wireless communications network or to a User Data Repository, UDR, the received indication of the traffic steering policy for the specific traffic on the specific user session associated with the wireless communications device.

The specific user session associated with the wireless communications device may be a user PDU session.

According to a fourth aspect of embodiments herein, the object is achieved by a second network node implementing a NEF in a wireless communications network. The second network node is configured for influencing traffic routing associated with a wireless communications device in the wireless communications network. The second network node is further configured for performing the method according to the third aspect above.

According to a fifth aspect of embodiments herein, the object is achieved by a method, performed by a third network node implementing a PCF in a wireless communications network, for influencing traffic routing associated with a wireless communications device in the wireless communications network, the method comprises:
receiving, from a first network node or from a second network node or from a User Data Repository, UDR, an indication of a traffic steering policy for a specific traffic on a specific user session associated with the wireless communications device, and
creating a Policy Charging and Control, PCC, rule based on the indication of the traffic steering policy for the specific traffic on the specific user session.

The specific user session associated with the wireless communications device may be a user PDU session.

According to a sixth aspect of embodiments herein, the object is achieved by a third network node implementing a PCF in a wireless communications network. The third network node is configured for influencing traffic routing associated with a wireless communications device in the wireless communications network. The third network node is further configured for performing the method according to the fifth aspect above.

According to a further aspect, the object is achieved by a computer program comprising instructions, such as computer readable code units, which when executed by a processor of a network node, causes the network node to perform actions according to any of the aspects above.

According to a further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

Since the request to influence the traffic routing associated with the wireless communications device includes an indication of the traffic steering policy for the specific traffic, such as DL or UL traffic, on the specific user session associated with the wireless communications device the request may be used for asymmetric SFC where for example uplink and downlink paths differs.

### BRIEF DESCRIPTION OF THE DRAWINGS

In the figures, features that appear in some embodiments are indicated by dashed lines.

The various aspects of embodiments disclosed herein, including particular features and advantages thereof, will be readily understood from the following detailed description and the accompanying drawings, in which:

FIG. 1 illustrates a simplified wireless communication system,

FIG. 2 is a block diagram schematically illustrating a 5G reference architecture of policy and charging control framework as defined by 3GPP,

FIG. 3 is a block diagram schematically illustrating a wireless communication system,

FIG. 4 is a block diagram schematically illustrating a network architecture of a policy and charging control framework according to some embodiments herein,

FIG. 5 is a sequence diagram describing embodiments herein,

FIG. 6 is a flowchart illustrating embodiments of a method for influencing traffic routing associated with a wireless communications device in a wireless communications network performed by a first network node,

FIG. 7 is a flowchart illustrating embodiments of a method for influencing traffic routing associated with a wireless communications device in a wireless communications network performed by a second network node,

FIG. 8 is a flowchart illustrating embodiments of a method for influencing traffic routing associated with a wireless communications device in a wireless communications network performed by a third network node,

FIG. 9 is a schematic block diagram illustrating embodiments of a first network node,

FIG. 10 is a schematic block diagram illustrating embodiments of a second network node,

FIG. 11 is a schematic block diagram illustrating embodiments of a third network node,

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

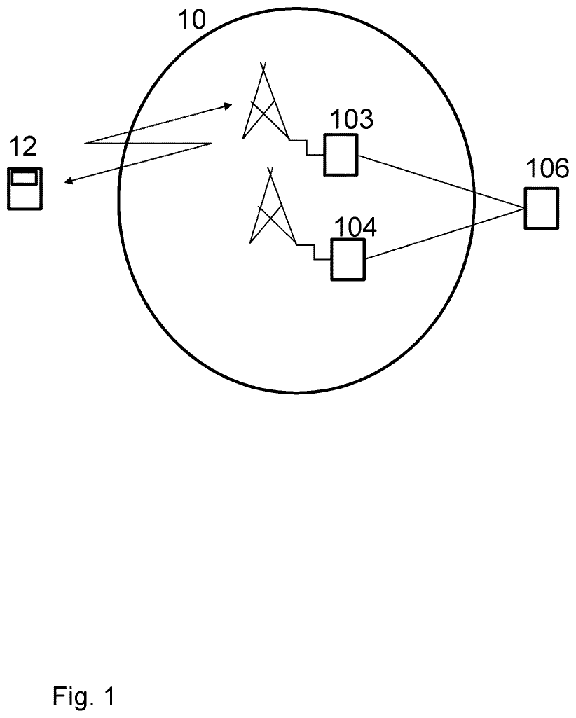

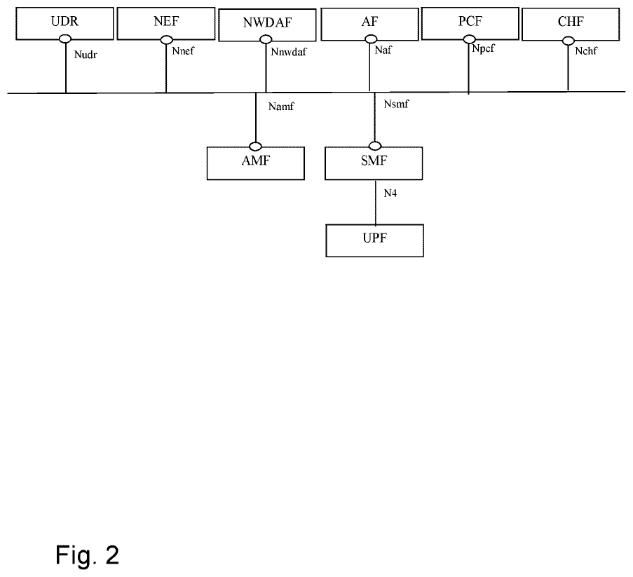

### DETAILED DESCRIPTION

As mentioned above, there are challenges and issues with how to influence traffic routing.

An object of embodiments herein is therefore to improve methods for influencing traffic routing.

Embodiments herein provide mechanisms for an AF to influence directly on uplink and downlink traffic steering policies associated to a specific UE, target group of UEs, and specific flow per specific DNAI.

Embodiments herein have the following advantages:
They solve a problem where current routing profile ID which is used by AF to provide traffic routing requirements refer to a single traffic steering policy so it can not differentiate into uplink and downlink paths that in fact is already supported in the interfaces between PCF, SMF and UPF. The routing profile ID refers to a pre-agreed policy between the AF and the 5GC. This policy may refer to different steering policy ID(s) sent to SMF and e.g. based on time of the day etc.
They avoid ad-hoc, non-standard workarounds like e.g., PCF mapping of multiple routing profiles ID criteria and specific Traffic Policies.
They enable asymmetric SFC requested from AF.
They enhance coordination between SFC providers and operators in 5GC.

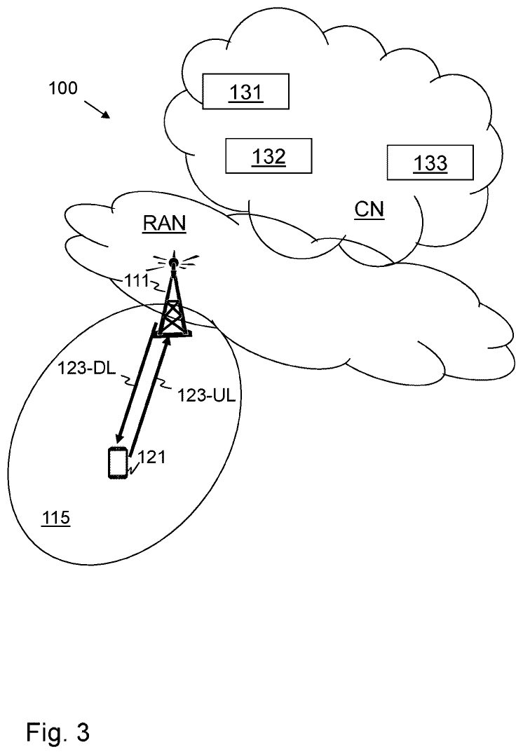

Embodiments herein relate to communication networks in general, and specifically to wireless communication networks. FIG. 3 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G and/or future 6G context. However, embodiments are also applicable in further development of the existing wireless communication systems such as e.g. WCDMA and LTE.

Access nodes operate in the wireless communications network 100 such as a radio access node 111. The radio access node 111 provides radio coverage over a geographical area, a service area referred to as a cell 115, which may also be referred to as a beam or a beam group of a first radio access technology (RAT), such as 5G, LTE, Wi-Fi or similar. The radio access node 111 may be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective radio access node 111 may be referred to as a serving radio access node and communicates with a UE with Downlink (DL) transmissions on a DL channel 123-DL to the UE and Uplink (UL) transmissions on an UL channel 123-UL from the UE.

A number of wireless communications devices operate in the wireless communication network 100, such as a UE 121.

The UE 121 may be a mobile station, a non-access point (non-AP) STA, a STA, a user equipment and/or a wireless terminal, that communicate via one or more Access Networks (AN), e.g. RAN, e.g. via the radio access node 111 to one or more core networks (CN) e.g. comprising a first CN node 131, for example implementing an AF. The CN may further comprise second CN node 132, for example implementing a NEF. The CN may further comprise third CN node 133, for example implementing a PCF.

It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

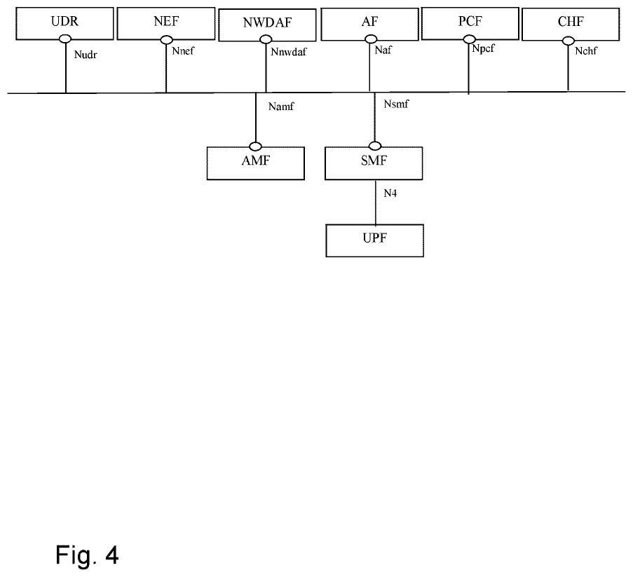

FIG. 4 depicts a network architecture of a policy and charging control framework according to some embodiments herein. Functions that are important for understanding embodiments disclosed herein will be described below.

### AF

In scenarios related to embodiments herein the AF may influence traffic routing in 5GC.

### PCF (Policy Control Function)

In scenarios related to embodiments herein the PCF is the receiver, directly or through the UDR, or the NEF, of AF information to influence traffic routing in 5GC.

### SMF (Session Management Function)

In scenarios related to embodiments herein the SMF may receive dynamic PCC rules from the PCF with traffic routing information or traffic steering policies for uplink and downlink. It also may hold pre-defined PCC rules with pre-configured traffic steering policies (TSP) for uplink and downlink.

### UPF (User Plane Function)

In scenarios related to embodiments herein the UPF may receive forwarding parameters specifying the policy to follow when a Packet Detection Rule (PDR) is matched. That is, in both directions uplink and downlink parameters shall be specified in different PDRs.

Embodiments herein are based on the following:
The AF adds new elements (marked in bold below and with text “*** NEW” after the added element) in a routing information influence API e.g.

```
RouteToLocation:
    type: object
    properties:
      dnai:
        $ref: ‘#/components/schemas/Dnai’
      routeInfo:
        $ref: ‘#/components/schemas/RouteInformation’
      routeProfId:
        type: string
        nullable: true
      trafficSteeringPolicyDI: *** NEW
        type: string
        nullable: true
      trafficSteeringPolicyUI: *** NEW
        type: string
        nullable: true
required:
- dnai
    anyOf:
      - required: [ routeInfo ]
      - required: [ routeProfId ]
      - required: [ trafficSteeringPolicyDI] *** NEW
      - required: [ trafficSteeringPolicyUI] *** NEW
    nullable: true
  RouteInformation:
    type: object
    properties:
      ipv4Addr:
        $ref: ‘#/components/schemas/Ipv4Addr’
      ipv6Addr:
        $ref: ‘#/components/schemas/Ipv6Addr’
      portNumber:
        $ref: ‘#/components/schemas/Uinteger’
    required:
      - portNumber
    nullable: true
```

Thus, the AF may add the new elements in a message comprising routing influencing information. The message may be sent using an API.
UDR/NEF as indirect element may store and forward the new elements to PCF as it does with rest of routing influence information managed so far.
PCF may transparently associate AF-TSPs explicit information with steering policies, or alternately maps to local TSP configured values, e.g., to isolate the AF from further system configuration changes, or predefined-rules and send to the SMF.
SMF and UPF are not impacted as already they manage uplink and downlink steering policies for a given flow.

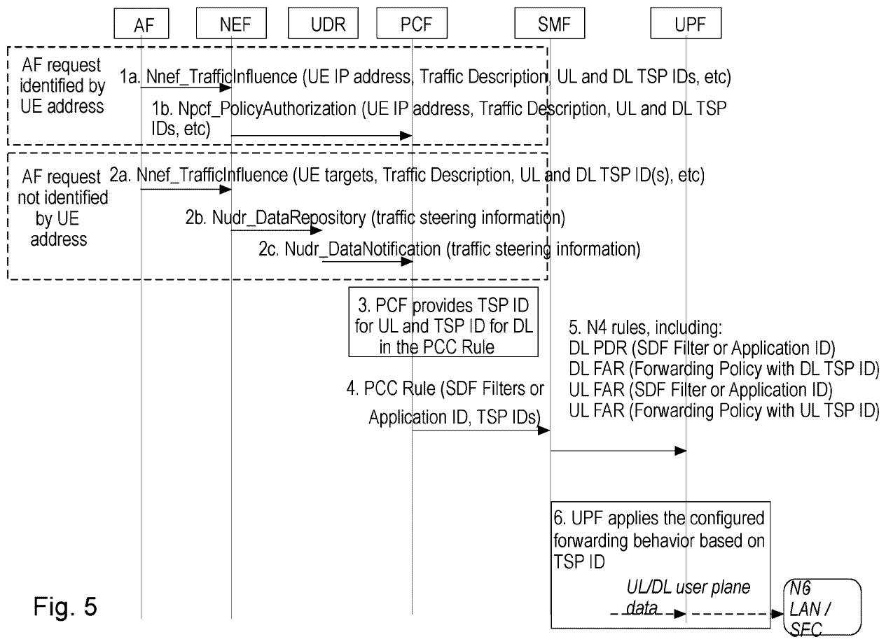

FIG. 5 shows a sequence diagram and participating network nodes describing embodiments herein and showing an example of how to apply traffic influence using the NEF for specific UE IP address or the UDR for UE targets, such as a wireless communications device or a group of wireless communications devices, identified by a network public identity.

### Description of Sequence Diagram:

1. a The AF may use an API, such as Nnef_TrafficInfluence API, to influence how to route a specific traffic on a specific user session, such as a PDU session, by providing a UE IP address together with the request. The AF may include Traffic Steering Policy IDs, identifying specific traffic steering policies such as a specific traffic steering policy for DL and/or a specific traffic steering policy for UL, in the request.

1.b The NEF identifies the PCF serving the PDU Session and triggers an Npcf_PolicyAuthorization Request, for example as described in 3GPP TS 23.502 v17.4.0 “Procedures for the 5G system, Stage 2”, clause 4.3.6.4.

2. a AF may use Nnef_TrafficInfluence API to influence how to route a specific traffic for a UE or a group of UEs, by providing UE ID such as a Generic Public Subscription Identifier (GPSI) or External Group ID together with the request. 5G System supports management of 5G Virtual Network (VN) Group identification and membership (i.e. definition of 5G VN group identifiers and membership) and 5G VN Group data (i.e. definition of 5G VN group data). The 5G VN Group management may be configured by a network administrator or may be managed dynamically by AF.

A 5G VN group may comprise of a set of UEs using private communication for 5G LAN-type services and is characterized by the following:

5G VN group identities: External Group ID and Internal Group ID are used to identify the 5G VN group.

The AF may include Traffic Steering Policy IDs, such as DL TSP ID and/or UL TSP ID, in the request.

2.b The NEF may store the information in the UDR, as described in 3GPP TS 23.502, clause 4.3.6.2.

2.c The UDR may provide the stored traffic steering information to the PCF, e.g., through an API Nudr_DataNotification.

3. The PCF uses TSP explicit request coming from AF and uses the TSP ID for UL and/or the TSP ID for DL in corresponding PCC rule(s). That is, the PCF transforms the TSP ID for UL and/or the TSP ID for DL into corresponding PCC rule(s).

4. The PCF may send PCC rule(s) to the SMF. The PCC Rule may comprise SDF Filters or Application ID and TSP IDs.

5. The SMF may send Packet Detection Rules, PDRs, information to identify the specific traffic and Forwarding Action Rules, FAR, with forwarding policies according to the TSP ID for UL and/or TSP ID for DL to request the UPF to forward the specific traffic according to these TSPs

6. UPF may apply the PDRs and specific forwarding policies based on TSP ID. User data traffic will at some point in time arrive at the UPF which will forward the user data traffic to N6-LAN. N6 is a reference point between the UPF and the DN. N6-LAN is a Local Area Network (LAN) between the 5GC and a DN. In N6-LAN Service Functions (SFs), such as proxies and Network Address Translations (NATs) are deployed that rely on service function chaining technology to make sure specific traffic is steered through the right SFs.

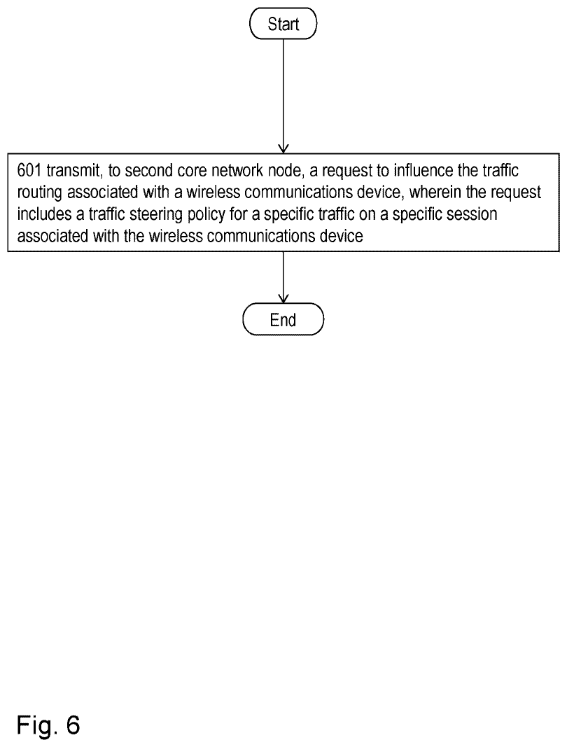

Exemplifying methods according to embodiments herein will now be described with reference to a flow chart in FIG. 6. The flow chart illustrates a method, performed by the first network node 131 for influencing traffic routing associated with the wireless communications device 121 in the wireless communications network 100.

In action 601, the first network node 131 transmits, to a second network node 132 implementing a network exposure function of the wireless communications network 100, a request to influence the traffic routing associated with the wireless communications device 121. The request includes a traffic steering policy for a specific traffic on a specific user session associated with the wireless communications device 121.

The indication of the traffic steering policy may include an indication of a first traffic steering policy for uplink traffic and/or a second traffic steering policy for downlink traffic. In some embodiments herein the indication of the traffic steering policy includes identifiers of the traffic steering policy. For example, the indication of the traffic steering policy may include TSP IDs, such as DL TSP ID and/or UL TSP ID, in the request.

The specific user session associated with the wireless communications device 121 may be a user PDU session.

The indication of the traffic steering policy may be associated to a specific UE, target group of UEs, and specific flow per specific DNAI.

In some embodiments herein the request to the second network node 132 or the third network node 133 further includes a network address of the wireless communications device 121 or includes a network public identity of the wireless communications device 121 or of a group of wireless communications devices 121.

The indication of the traffic steering policy for the specific traffic on the specific user session may be specific to an access to a DN identified by the DNAI in the request.

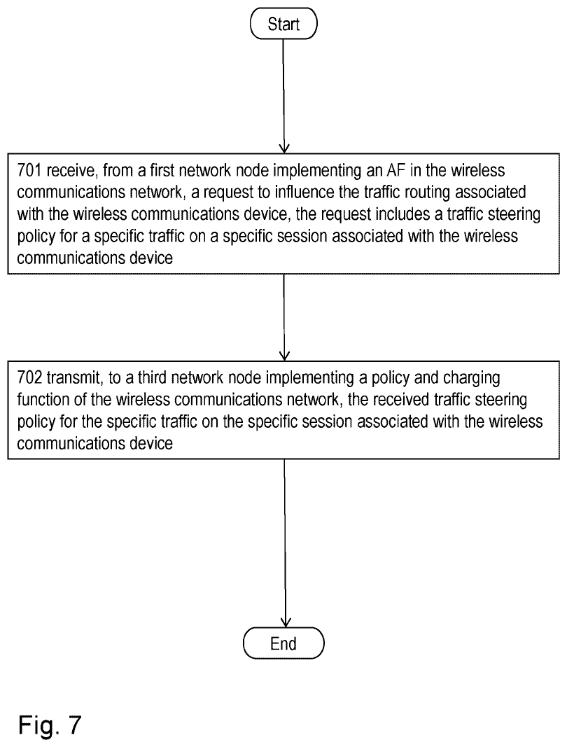

Exemplifying methods according to embodiments herein will now be described with reference to a flow chart in FIG. 7. The flow chart illustrates a method, performed by the second network node 132 for influencing traffic routing associated with the wireless communications device 121 in the wireless communications network 100.

The method actions of FIG. 7 are not necessarily performed in the described order but may be performed in any suitable order.

In action 701 the second network node 132 receives, from the first network node 131, implementing the AF in the wireless communications network 100, a request to influence the traffic routing associated with the wireless communications device 121. The request includes a traffic steering policy for the specific traffic on the specific user session associated with the wireless communications device 121.

For example, the indication of the traffic steering policy may include TSP IDs, such as DL TSP ID and/or UL TSP ID, in the request.

The indication of the traffic steering policy may be associated to a specific UE, target group of UEs, and specific flow per specific DNAI.

In action 702 the second network node 132 transmits, to the third network node 133, implementing the policy and charging function of the wireless communications network, the received traffic steering policy for the specific traffic on the specific user session associated with the wireless communications device 121.

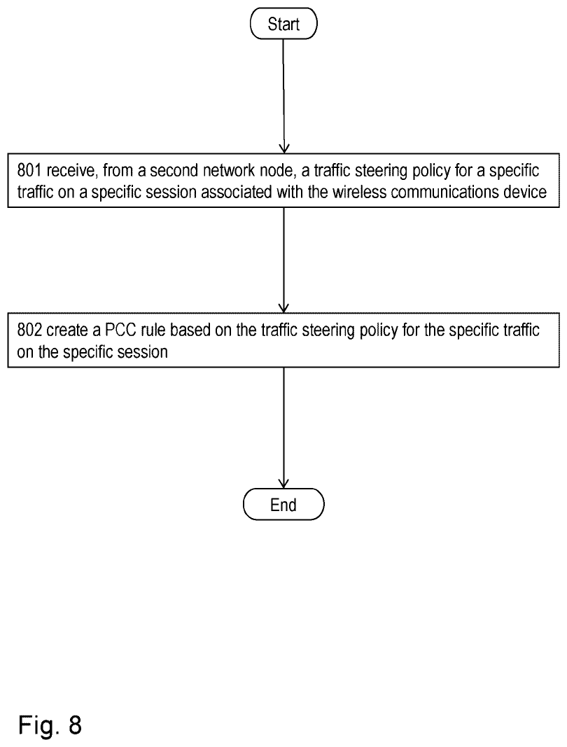

Exemplifying methods according to embodiments herein will now be described with reference to a flow chart in FIG. 8. The flow chart illustrates a method, performed by the third network node 133 for influencing traffic routing associated with the wireless communications device 121 in the wireless communications network 100.

The method actions of FIG. 8 are not necessarily performed in the described order but may be performed in any suitable order.

In action 801 the third network node 133 receives, from the second network node 132, a traffic steering policy for the specific traffic on the specific user session associated with the wireless communications device 121.

In action 802 the third network node 133 creates a PCC rule based on the traffic steering policy for the specific traffic on the specific user session.

For example, the third network node 133 may use a TSP explicit request coming from the first network node 131 and use the TSP ID for UL and/or the TSP ID for DL to create corresponding PCC rule(s). The third network node 133 may send the PCC rule(s) to the SMF.

### Further Detailed Example Embodiments

Embodiments herein provide a solution to the problems mentioned above by enhancing the AF's influence on traffic steering by adding traffic steering policies for specific traffic. Thus, embodiments herein enable the AF to request predefined SFC for traffic flow(s) related with target UE(s). Thus, the AF may influence with explicit traffic steering policies per flow.

In order to fulfill uplink and downlink different traffic steering policies using AF routing influence directly, new elements may be added in the interface so that UL and DL traffic steering policies may be provided for the specific traffic and traffic direction.

The PCF shall check and apply the request. The required PCC rules are provisioned to include or modify traffic steering policies for UL and DL traffic steering according to what has been required from AF directly or through NEF.

In some embodiments herein the PCC rule either indicates traffic steering or N6 traffic routing, but not both simultaneously. Therefore, in order to not impact further in PCF, SMF and UPF, a proposal is to add new traffic steering rules for DL and UL in a mutually exclusive way with current routing info and/or routing profile ID.

This solution thus proposes to add UL Traffic Steering Policy ID and DL Traffic Steering Policy ID to the existing Nnef_TrafficInfluence and NpcfPolicyAutorization, Nudr_DataNotification. The AF request may either contain UL and DL AF-TSP IDs, or just one if any of the direction does not require any steering policy, for Service Chaining or Traffic Routes for steering to a local DN, but not both Service Chaining and Traffic Routes for steering to the local DN. PCF may use AF-TSP IDs directly or maps to local defined TSP ID provided to the SMF in the PCC Rule to avoid the AF to know how TSP ID are set in the 5GC and therefore isolate it from system configuration changes, i.e. the TSP IDs configured in the 5GC may be modified without impacting the UL Traffic Steering Policy ID and DL Traffic Steering Policy ID that the AF uses (AF-TSP IDs).

### Impacts on Existing Nodes and Functionality

AF: Support of providing new information in the Nnef_TrafficInfluence API, to provide explicitly UL and DL traffic steering policy, such as AF-TSPs, in its requests or only one of them.

NEF: Support of new information in the Nnef_TrafficInfluence API, and pass it to UDR and PCF.

UDR: Supports storage of AF-TSP IDs in the AF influence on routing parameters.

PCF: Accepts new information and uses it or maps to local TSP defined, as traffic steering policies associated to the PCC rule(s) impacted.

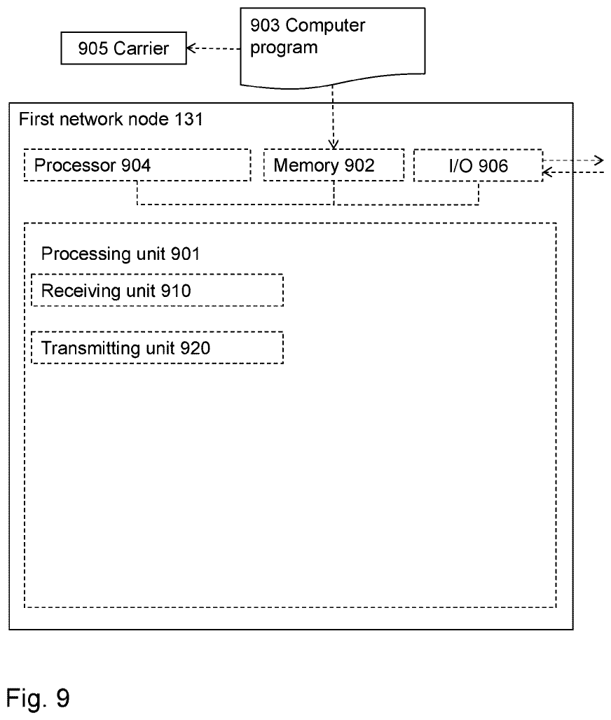

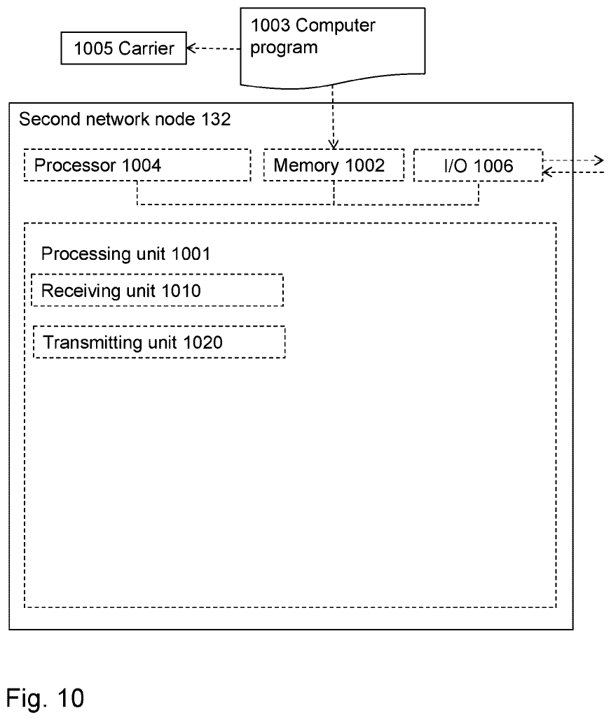

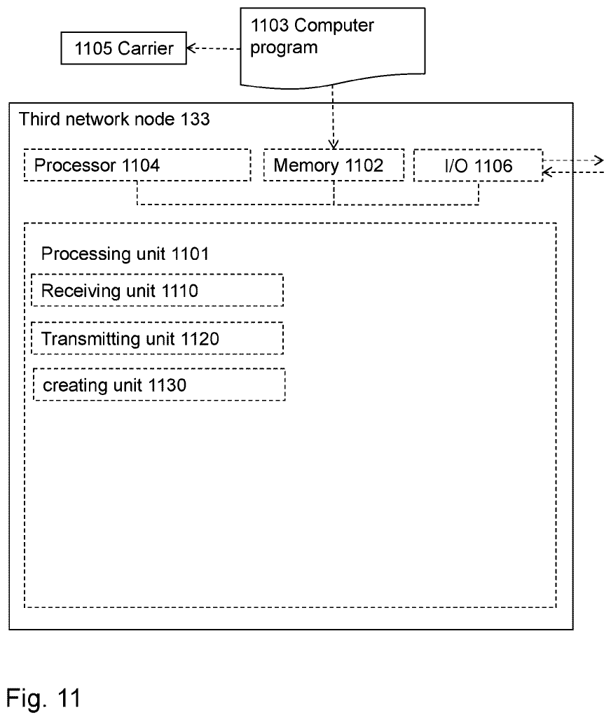

FIG. 9 shows an example of the first network node 131, FIG. 10 shows an example of the second network node 132 and FIG. 11 shows an example of the third network node 133. The first network node 131 may be configured to perform the method actions of FIG. 6 and some of the method actions of FIG. 5. The second network node 132 may be configured to perform the method actions of FIG. 7 and some of the method actions of FIG. 5 above. The third network node 133 may be configured to perform the method actions of FIG. 8 and some of the method actions of FIG. 5 above. In summary, the first second and third network nodes 131, 132, 133 are each configured for influencing traffic routing associated with the wireless communications device 121 in the wireless communications network 100 according to the method actions described above.

The first network node 131, the second network node 132 and the third network node 133 may comprise a respective input and output interface, IF, 906, 1006, 1106 configured to communicate with each other, see FIGS. 9-11. The input and output interface may comprise a wireless receiver (not shown) and a wireless transmitter (not shown).

The first network node 131, the second network node 132 and the third network node 133 may further comprise a respective receiving unit 910, 1010, 1110, and transmitting unit 920, 1020, 1120, see FIGS. 9, 10 and 11 which may receive and transmit messages and/or signals.

The third network node 133 may further comprise a creating unit 1130 which for example may create a PCC rule based on the traffic steering policy for the specific traffic on the specific user session. For example, the third network node 133 and/or the creating unit 1130 may be configured to use a TSP explicit request coming from the first network node 131 and use the TSP ID for UL and/or the TSP ID for DL to create corresponding PCC rule(s).

The third network node 133 may further be configured to create the PCC rule by being configured to map the routing information, e.g. Routing Profile IDs, received from the first network node 131, to the RouteToLocation parameters provided in the PCC Rule.

The embodiments herein may be implemented through a respective processor or one or more processors, such as the respective processor 904, 1004, and 1104, of a processing circuitry in the first network node 131, the second network node 132 and the third network node 133 and depicted in FIGS. 9-11 together with computer program code for performing the functions and actions of the embodiments herein. The program code mentioned above may also be provided as a computer program product, for instance in the form of a data carrier carrying computer program code for performing the embodiments herein when being loaded into the respective first network node 131, the second network node 132 and the third network node 133. One such carrier may be in the form of a CD ROM disc. It is however feasible with other data carriers such as a memory stick. The computer program code may furthermore be provided as pure program code on a server and downloaded to the respective first network node 131, the second network node 132 and the third network node 133.

The first network node 131, the second network node 132 and the third network node 133 may further comprise a respective memory 902, 1002, and 1102 comprising one or more memory units. The memory comprises instructions executable by the processor in the first network node 131, the second network node 132 and the third network node 133.

Each respective memory 902, 1002 and 1102 is arranged to be used to store e.g. information, data, configurations, and applications to perform the methods herein when being executed in the respective first network node 131, the second network node 132 and the third network node 133.

The first network node 131 is configured to transmit, to the second network node 132 implementing the network exposure function of the wireless communications network 100 or to the third network node 133 implementing the policy and charging function of the wireless communications network 100, the request to influence the traffic routing associated with the wireless communications device 121. The request includes the indication of the traffic steering policy for the specific traffic on the specific user session associated with the wireless communications device 121. The specific user session associated with the wireless communications device 121 may be a user PDU session.

The first network node 131 and/or the processor 904 may be configured to include the indication of the first traffic steering policy for uplink traffic and/or the second traffic steering policy for downlink traffic in the indication of the traffic steering policy.

In some embodiments the first network node 131 and/or the processor 904 is configured to include the identifiers of the traffic steering policy in the indication of the traffic steering policy.

The first network node 131 and/or the processor 904 may be configured to include the network address of the wireless communications device 121 or the network public identity of the wireless communications device 121 or of the group of wireless communications devices in the 121 request to the second network node (132) or the third network node (133).

The second network node 132 is configured to receive, from the first network node 131 implementing the AF in the wireless communications network 100, the request to influence the traffic routing associated with the wireless communications device 121. The request includes the indication of the traffic steering policy for the specific traffic on the specific user session associated with the wireless communications device 121.

The second network node 132 is further configured to transmit, to the third network node 133 implementing the policy and charging function of the wireless communications network 100 or to the UDR 503 the received indication of the traffic steering policy for the specific traffic on the specific user session associated with the wireless communications device 121.

The third network node 133 is configured to receive, from the first network node 131 or from the second network node 132 or from the UDR, the indication of the traffic steering policy for the specific traffic on the specific user session associated with the wireless communications device 121.

The third network node 133 and/or the processor 1104 is further configured to create the PCC rule based on the indication of the traffic steering policy for the specific traffic on the specific user session.

The second network node 132 and the third network node 133 are each configured to receive the first traffic steering policy for uplink traffic and/or the second traffic steering policy for downlink traffic included in the received indication of the traffic steering policy.

In some embodiments, a respective computer program 903, 1003 and 1103 comprises instructions, which when executed by the at least one processor, cause the at least one processor of the respective first network node 131, the second network node 132 and the third network node 133 to perform the actions above. The respective computer program 903, 1003 and 1103 may be loaded into the respective memory 902, 1002, and 1102.

In some embodiments, a respective carrier 905, 1005 and 1105 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units described above may refer to a combination of analog and digital circuits, and/or one or more processors configured with software and/or firmware, e.g. stored in the respective wireless communications device 601 and network node 602, that when executed by the respective one or more processors such as the processors described above. One or more of these processors, as well as the other digital hardware, may be included in a single Application-Specific Integrated Circuitry ASIC), or several processors and various digital hardware may be distributed among several separate components, whether individually packaged or assembled into a system-on-a-chip (SoC).

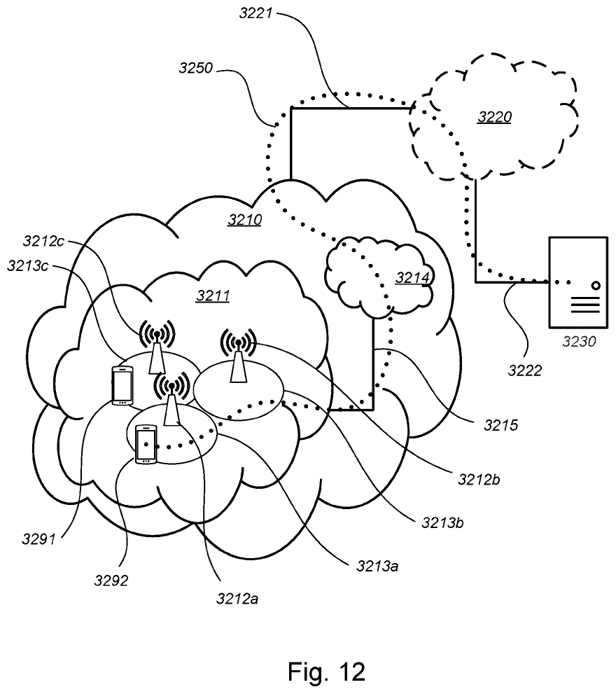

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 such as e.g. the UE 121, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291.

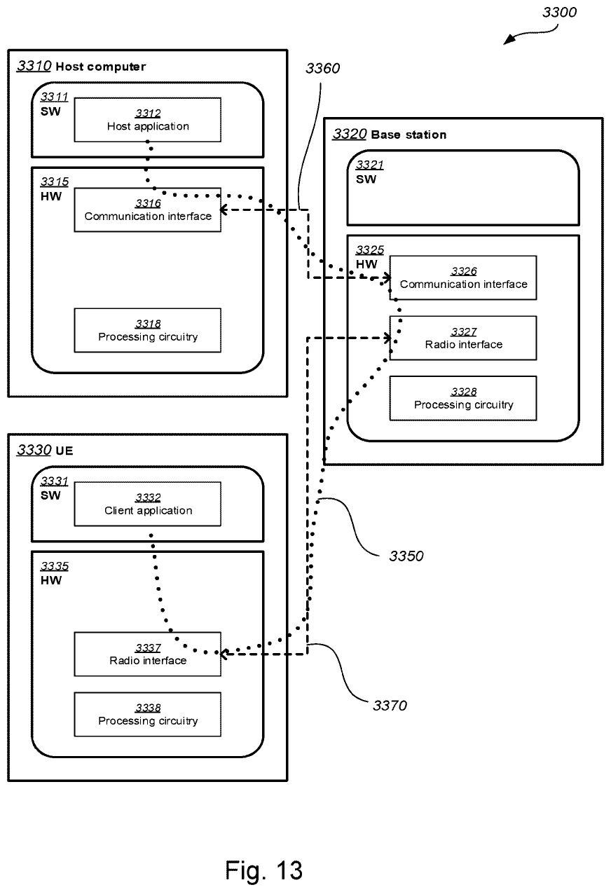

Similarly, the base station 3212 need not be aware of the future routing of an outgoing uplink communication originating from the UE 3291 towards the host computer 3230. Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

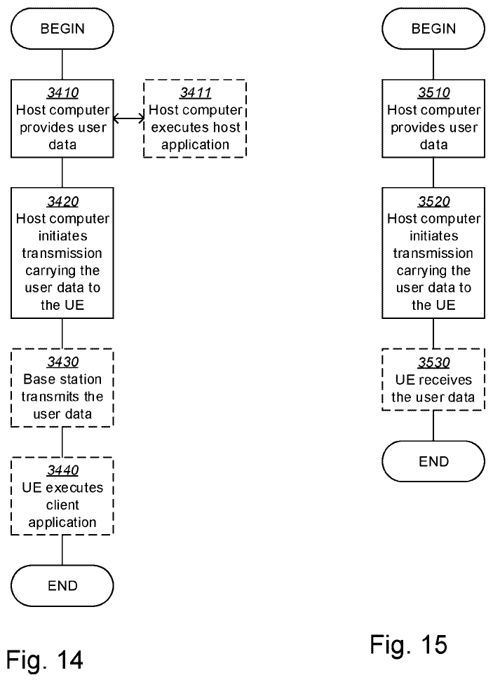

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 14 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 15 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

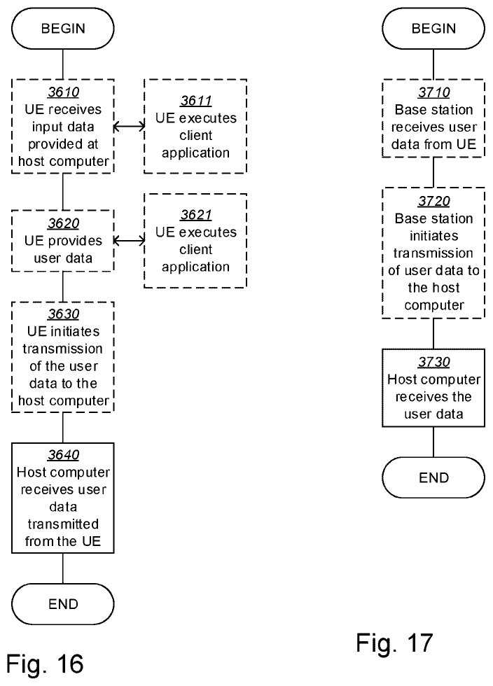

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 16 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 17 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### Abbreviations

AF Application Function
AMF Access and Mobility Function
AOI Area of Interest
AS Application Server
CP Control Plane
DNAI Data network Area Identifier
DNN Data Network Name
IE Information Element
IMSI International Mobile Subscriber Identifier
IP Internet Protocol
MBB Mobile Broadband
ML Machine Learning
MNO Mobile Network Operator
NF Network Function
NR Next Generation Radio/New Radio
NRF Network Repository Function
NWDAF Network Data Analytics Function
OAM Operation Administration and Maintenance
PCC Policy Charging and Control
PCEF Policy and Charging Enforcement Function
PCF Policy Control Function
PCRF Policy Control Rules Function
PDN Packet Data Network
PDR Packet Detection Rule
PEI Permanent Equipment Identity
PFCP Packet Flow Control Protocol
PFD Packet Flow Description
PGW Packet Gateway
PGW-C PDN Gateway Control plane function
PGW-U PDN Gateway User plane function
PSA PDU Session Anchor
PUI Public User Identity
QOS Quality of Service
RAN Radio Access Network
SDF Service Data Flow
SF Service Function
SFC Service Function Chaining
SMF Session Management Function
S-NSSAI Single Network Slice Selection Assistance Information
SUPI Subscription Permanent Identifier
TSP Traffic Steering Policy
UDR Unified Data Repository
UE User Equipment
UP User Plane
UPF User Plane Function
PUI Public User Identity
QOS Quality of Service
RAN Radio Access Network
SDF Service Data Flow
SF Service Function
SFC Service Function Chaining
SMF Session Management Function
S-NSSAI Single Network Slice Selection Assistance Information
SUPI Subscription Permanent Identifier
TSP Traffic Steering Policy
UDR Unified Data Repository
UE User Equipment
UP User Plane
UPF User Plane Function

### Numbered Embodiments

1. A method, performed by a first network node implementing an AF in a wireless communications network for influencing traffic routing associated with a wireless communications device in the wireless communications network, the method comprises:
   transmitting, to a second network node implementing a network exposure function of the wireless communications network, a request to influence the traffic routing associated with the wireless communications device, wherein the request includes a traffic steering policy for a specific traffic on a specific session associated with the wireless communications device.
2. The method according to embodiment 1, wherein the request to the second network node includes a first traffic steering policy for uplink traffic and/or a second traffic steering policy for downlink traffic.
3. The method according to any of the embodiments 1-2, wherein the request to the second network node further identifiers of the traffic steering policy.
4. The method according to any of the embodiments 1-3, wherein the request to the second network node further includes a network address of the wireless communications device.
5. The method according to any of the embodiments 1-3, wherein the request to the second network node is identified by the network address of the wireless communications device.
6. A method, performed by a second network node implementing a network exposure function of the wireless communications network, for influencing traffic routing associated with a wireless communications device in the wireless communications network, the method comprises:
   receiving, from a first network node implementing an AF in the wireless communications network, a request to influence the traffic routing associated with the wireless communications device, wherein the request includes a traffic steering policy for a specific traffic on a specific session associated with the wireless communications device, and
   transmitting, to a third network node implementing a policy and charging function of the wireless communications network, the received traffic steering policy for the specific traffic on the specific session associated with the wireless communications device.
7. A method, performed by a third network node implementing a policy and charging function of the wireless communications network, for influencing traffic routing associated with a wireless communications device in the wireless communications network, the method comprises:
   receiving, from a second network node, a traffic steering policy for a specific traffic on a specific session associated with the wireless communications device, and
   creating a PCC rule based on the traffic steering policy for the specific traffic on the specific session.
8. The method according to embodiment 7, wherein the traffic steering policy for the specific traffic on the specific session includes a first traffic steering policy for uplink traffic and/or a second traffic steering policy for downlink traffic.
9. The method according to any of the embodiments 7-8, further comprising receiving a network address of the wireless communications device.

1. A method, performed by a first network node (131) implementing an Application Function, AF, in a wireless communications network (100) for influencing traffic routing associated with a wireless communications device (121) in the wireless communications network (100), the method comprises:
transmitting (601), to a second network node (132) implementing a network exposure function of the wireless communications network (100) or to a third network node (133) implementing a policy and charging function of the wireless communications network (100), a request to influence the traffic routing associated with the wireless communications device (121), wherein the request includes an indication of a traffic steering policy for a specific traffic on a specific user session associated with the wireless communications device (121).

2. The method according to claim 1, wherein the indication of the traffic steering policy includes an indication of a first traffic steering policy for uplink traffic and/or a second traffic steering policy for downlink traffic.

3. The method according to claim 1, wherein the indication of the traffic steering policy includes identifiers of the traffic steering policy.

4. The method according to claim 1, wherein the request to the second network node (132) or the third network node (133) further includes a network address of the wireless communications device (121) or includes a network public identity of the wireless communications device (121) or of a group of wireless communications devices (121).

5. The method according to claim 1, wherein the specific user session associated with the wireless communications device (121) is a user Protocol Data Unit, PDU, session.

6. The method according to claim 1, wherein the indication of the traffic steering policy for the specific traffic on the specific user session is specific to an access to a data network identified by a Data Network Access Identifier, DNAI, in the request.

7. A method, performed by a second network node (132) implementing a network exposure function of the wireless communications network (100), for influencing traffic routing associated with a wireless communications device (121) in the wireless communications network (100), the method comprises:
receiving (701, from a first network node (131) implementing an Application Function, AF, in the wireless communications network (100), a request to influence the traffic routing associated with the wireless communications device (121), wherein the request includes an indication of a traffic steering policy for a specific traffic on a specific user session associated with the wireless communications device (121), and
transmitting (702), to a third network node (133) implementing a policy and charging function of the wireless communications network (100) or to a User Data Repository, UDR, (503) the received indication of the traffic steering policy for the specific traffic on the specific user session associated with the wireless communications device (121).

8. The method according to claim 7, wherein the indication of the traffic steering policy includes identifiers of the traffic steering policy.

9. The method according to claim 7, wherein the received indication of the traffic steering policy for the specific traffic on the specific user session includes a first traffic steering policy for uplink traffic and/or a second traffic steering policy for downlink traffic.

10. The method according to claim 7, wherein the received indication of the traffic steering policy further comprises a network address of the wireless communications device (121).

11. A first network node (131) implementing an Application Function, AF, in a wireless communications network (100) and configured for influencing traffic routing associated with a wireless communications device (121) in the wireless communications network (100), the first network node (131) is further configured to:
transmit, to a second network node (132) implementing a network exposure function of the wireless communications network (100) or to a third network node (133) implementing a policy and charging function of the wireless communications network (100), a request to influence the traffic routing associated with the wireless communications device (121), wherein the request includes an indication of a traffic steering policy for a specific traffic on a specific user session associated with the wireless communications device (121).

12. The first network node (131) according to claim 11, wherein the indication of the traffic steering policy includes an indication of a first traffic steering policy for uplink traffic and/or a second traffic steering policy for downlink traffic.

13. The first network node according to claim 11, wherein the indication of the traffic steering policy includes identifiers of the traffic steering policy.

14. The first network node according to claim 11, wherein the request to the second network node (132) or the third network node (133) further includes a network address of the wireless communications device (121) or includes a network public identity of the wireless communications device (121) or of a group of wireless communications devices (121).

15. The first network node according to claim 11, wherein the specific user session associated with the wireless communications device (121) is a user Protocol Data Unit, PDU, session.

16. A computer program (1003), comprising computer readable code units which when executed on a network node (131, 132, 133) causes the network node (131, 132, 133) to perform the method according to claim 1.

17. A carrier (1005) comprising the computer program according to claim 16, wherein the carrier (1005) is one of an electronic signal, an optical signal, a radio signal and a computer readable medium.
